(19) United States
(12) Patent Application Publication
(10) Pub. No.: US 2024/0098111 A1
(43) Pub. Date: Mar. 21, 2024

(54) CHARACTERIZATION AND MITIGATION OF RANDOMIZED DDoS ATTACKS

(71) Applicant: Radware Ltd., Tel Aviv (IL)

(72) Inventors: Ehud DORON, Moddi'in (IL); Amnon LOTEM, Ramot Hashavim (IL); Gal YEHOSHUA, Kiryat Ono (IL); David AVIV, Tel Aviv (IL)

(73) Assignee: Radware Ltd., Tel Aviv (IL)

(21) Appl. No.: 17/933,404

(22) Filed: Sep. 19, 2022

(51) Int. Cl. H04L 9/40

(52) U.S. Cl. CPC H04L 63/1458

(57) ABSTRACT

A method and system for mitigating of randomized denial-of-service (DDoS) attacks directed against a protected entity during an attack time period are provided. The method includes receiving a packet during the attack time period; selecting a cluster defining legitimacy characteristics from at least one cluster of packets that best fits the received packet, wherein legitimacy characteristics of a cluster are learned during a peacetime period; determining a legitimacy score for the received packet based on the legitimacy characteristics of the selected cluster; determining based on the legitimacy score if the received packet is not legitimate; and applying a mitigation action on the received packet upon determination that the packet is not legitimate.

### TECHNICAL FIELD

This present disclosure generally relates to techniques for handling of randomized distributed denial of service (DDoS) attacks, and more specifically packet-based characterization and mitigation of randomized DDoS attacks.

### BACKGROUND

These days, online businesses and organizations are vulnerable to malicious attacks. Cyber-attacks are being committed using a wide and ever-changing arsenal of attack techniques and tools targeting both the information maintained by online businesses, their information technology (IT) infrastructure and the actual service availability. Hackers and attackers are constantly trying to improve their attack strategies to cause irrecoverable damage, overcome currently deployed protection mechanisms, and so on.

One type of popular cyber-attack is a DoS/DDoS attack, which is an attempt to make a computer or network resource unavailable or idle. A common technique for executing DoS/DDoS attacks includes saturating a target victim resource (e.g., a computer, a WEB server, an API server, a WEB application, and the like), with a large quantity of external requests or volume of traffic. As a result, the target victim network infrastructure becomes overloaded, and thus cannot assign the required resources and serve properly the legitimate traffic. When the attacker sends many applicative or other requests towards its victim resource, each victim resource would experience effects from the DoS attack. A DDoS attack is performed by controlling many machines and other entities and directing them to attack as a group, and may occur in layer 3 (network), layer 4 (transport), or layer 7 (application) of the open systems interconnections (OSI) model.

Attacks at the network layer, i.e., layer 3 of the OSI model, may include user datagram packet (UDP) reflection attacks, and occurs at the IP packet level. Layer 3 is where path determination and logical addressing occurs. Attacks at the transport layer, i.e., layer 4 of the OSI model, may include synchronization (SYN) floods, and occurs at the segments level.

Typically, attacks at layer 3 and layer 4 of the OSI model are referred to as infrastructure layer attacks. Large in volume they aim to overload the ability of the network, or the servers attached thereto to handle and serve properly the legitimate services traffic. On the bright side these attacks are easier to detect and mitigate because of their high volume and relatively distinct and static signatures.

The attackers therefore develop fast-morphing randomized DDoS attacks, which basically randomly morph the attack patterns. In fact, this is quite simple to achieve, but has devastating impact on the current state of solutions. These solutions assume that the attackers network layer traffic patterns are static over time, and therefore existing solution look after the static network layer signature of the attack, or in another word identifying and then backlisting the attacker's traffic, and by that achieve the accurate mitigation needed. However, when the attack traffic patterns are randomized and further is fast morphing it is practically impossible to know which packets belong to an attacker and which packets are legitimate. That is, the blacklisting-based solutions are not valid anymore because the patterns of the attack are random and change faster than it is possible to determine a blacklist for a particular packet or short-lived sequence of packets.

The detection of a randomized DDoS attack is possible using known in the art solutions, as it is involved with a higher than usual normal number of packets, or total bandwidth, being targeted at the attacked serve, i.e., the attacked server experiences a significant increase in traffic volume. However, this is insufficient because it cannot differentiate between legitimate packets and illegitimate packets which still results in the attacked server having to be neutralized or shutdown to avoid uncontrolled damage to service.

It would be, therefore, advantageous to provide an efficient security solution for the characterization and blocking of randomized DDoS attacks.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Some embodiments disclosed herein include a method for mitigation of randomized denial-of-service (DDoS) attacks directed against a protected entity during an attack time period, comprises of: receiving a packet during the attack time period; selecting a cluster defining legitimacy characteristics from at least one cluster of packets that best fits the received packet, wherein legitimacy characteristics of a cluster are learned during a peacetime period; determining a legitimacy score for the received packet based on the legitimacy characteristics of the selected cluster; determining based on the legitimacy score if the received packet is not legitimate; and, applying a mitigation action on the received packet upon determination that the packet is not legitimate.

Some embodiments disclosed herein include a system for mitigation of randomized denial-of-service (DDoS) attacks at attack time, comprises of: a processing circuitry; a network interface communicatively connected to the processing circuitry; and, a memory communicatively connected to the processing circuitry, a portion of the memory containing therein instructions that when executed by the processing circuitry configure the system to: receive a packet during the attack time period; selecting a cluster defining legitimacy characteristics from at least one cluster of packets that best fits the received packet, wherein legitimacy characteristics of a cluster are learned during a peacetime period; determine a legitimacy score for the received packet based on the legitimacy characteristics of the selected cluster; determine based on the legitimacy score if the received packet is not legitimate; and, apply a mitigation action on the received packet upon determination that the packet is not legitimate.

### BRIEF DESCRIPTION OF THE DRAWINGS

The subject matter as disclosed herein is particularly pointed out and distinctly claimed in the claims at the conclusion of the specification. The foregoing and other objects, features, and advantages of the various embodiments will be apparent from the following detailed description taken in conjunction with the accompanying drawings.

FIG. 1 is a schematic diagram utilized to describe the various embodiments for packet-based characterization and mitigation of randomized DDoS attacks according to some embodiments.

FIG. 2 is a schematic diagram of a system architecture for packet-based characterization and mitigation of randomized DDoS attacks according to an embodiment.

FIG. 3 is a schematic diagram of a positive security model implemented according to an embodiment.

FIG. 4 is a block diagram of a device utilized to carry the disclosed embodiments.

FIG. 5 is a flowchart of peacetime operation for packet-based characterization of randomized DDoS attacks according to an embodiment.

FIG. 6 is a flowchart of attack-time operation for packet-based mitigation of randomized DDoS attacks according to an embodiment.

FIG. 7A shows a legitimate source IP entropy detected according to an embodiment.

FIG. 7B shows a source IP entropy of a weak randomized DDoS attack detected according to an embodiment.

FIG. 7C shows a source IP entropy of a strong randomized DDoS attack detected according to an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Randomized distributed denial of service (DDoS) attacks are difficult to characterized using existing techniques as insufficient information is gathered before the attack pattern changes, and as attack patterns are substantially random, there is no practical way to back-list such attacks.

According to the disclosed embodiments a system and method for characterization and mitigating of randomized DDoS attacks that occur at layer 3 and/or layer 4 of the open systems interconnections (OSI) model are provided. The disclosed embodiments allow that during peacetime, i.e., when no attack is present, both baselines and clusters of packets that have one or more legitimacy characteristics are determined. Subsequently, upon detection of an attack, for example, due to increase of traffic beyond the expected normal baseline, the normal baselining ceases. Then, a threshold value is established to determine whether a received packet can be whitelisted according to its determined legitimacy characteristics, or that the packet should be blocked, again according to its determined legitimacy characteristics. The threshold value may be adjusted in real-time in order to ensure that blocking returns traffic to expected baseline.

The disclosed embodiments allow for fast mitigation of attack traffic while allowing legitimate traffic to reach its destination. As such, performance of protect entities provided services and legitimate clients experience are not affected by the attacker.

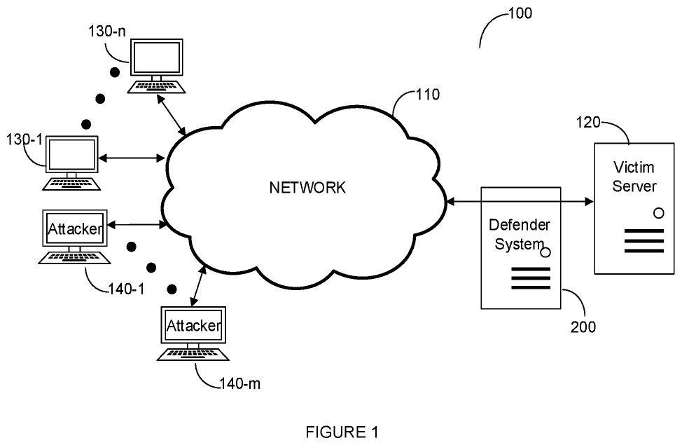

FIG. 1 is an example schematic diagram 100 utilized to describe the various embodiments for packet-based characterization and mitigation of randomized DDoS attacks according to some embodiments. In schematic diagram 100, client devices 130, for example client devices 130-1 through 130-n (where ‘n; is an integer equal to or greater than ‘1’) communicate with a server 120 over a network 110. To demonstrate the disclosed embodiments, the client device 130, for example client device 130-1, is a legitimate client (operated by a real legitimate user, or other legitimate client entities). To the network 110 there may be further connected one or more attackers, or attacker tools 140, for example attacker 140-1 through 140-m, where ‘m’ is an integer equal to or greater than ‘1’. The attacker 140, for example attacker 140-1, operates seemingly like a client device but is an attack tool (operated, for example, as a bot by a botnet) and uses randomization to change attack patterns, and the server 120 is a targeted victim of the attacker device 140-1, i.e., it is a “victim server” being under attack that is to be protected, and may also be referred to as a protected entity 120.

A legitimate client 130 can be a WEB browser, or other type of legitimate WEB application client, such as, but not limited to a business-to-business (B2B) application, an application program interface (API), and the like, executing over a computing device, such as a server, a mobile device, an IoT device, a laptop, a personal computer (PC), and the like. The legitimate client 130 communicate with the victim server 120 using transmission control protocol (TCP) over internet protocol (IP) and\or user datagram protocol (UDP) over IP, and\or maybe others protocol suites.

The attack tool 140 (also referred to herein as attacker) carries out malicious attacks against the victim server 120, and, for example, particularly carries out randomized network layer, i.e., layer 3 of the OSI model, attacks, transport layer, i.e., layer 4 of the OSI model, randomized flood attacks. Typically, the attacker uses randomization as a main attack strategy, in many cases generated attack traffic patterns do not always have the common traffic structures as required by a communication protocol.

The attack tool 140 may be a Flood attack tool operative at the transport layer of the OSI model. The attack tool sends floods of packets with a randomized content and may in most cases ignore an acknowledgement (ACK) and other response from the attacked target, or, may use a hacked IP address to supposedly send the randomized attack packets.

In another case the attack tool 140 may generate a UDP flood of packets, which also occurs at layer 4 of the OSI model. The attack tool 140 basically floods ports of the attacked target. In an embodiment, the attacked target then may check for applications listed at that port. As no application is found it must reply with a Destination Unreachable message. Because of the large number of UDP requests sent the attacked target resources are consumed and may lead, as intended by the attack tool 140, to inaccessibility of the attacked target. In other cases, various components of a network 110 infrastructure (switches, routers, FW, load-balancer and others) are overwhelmed by the attacker floods of packets, and as a result have no resources available to serve legitimate clients 130 traffic.

In a randomized attack at layer 3 or layer 4 of the OSI model, the randomized method may be operated by an attacker on a per packet basis, occur every predetermined or random period of time, or simply be random. Fields to randomization may include the likes of the header fields of protocols such as IP, UDP, or TCP. Fields may further include random selection of fields within the packet. The attacker can also randomize the packet size, by adding a random payload, size and content, to each of his generated packets. The most relevant fast morphing attacker patterns may have an attacker randomize each packet with spoofing of the source IP of each packet, each packet without spoofing, or each predetermined number (which may change periodically or randomly) of packets randomization. The randomization may further occur at the inter-packet level, where time between packets is hacked, where packets of an attacker may be sequenced one after the other, evenly distributed or sent out randomly in time.

It should be noted that the embodiments disclosed herein are applied when multiple attack tools 140 execute the attacks against the victim server 120 concurrently. Similarly, a vast number of legitimate client devices 130 can operate concurrently to be delivered with the services proposed by the server 120. Both client devices 130 and attackers 140 can reach the victim server 120 concurrently. The network 110 may be, but is not limited to, a local area network (LAN), a wide area network (WAN), the Internet, a private or public cloud network, a cellular network from various generation, and a metropolitan area network (MAN), wired network, wireless network, IoT network, or any combination thereof.

According to the disclosed embodiments, a defense system 200 is deployed between client 130, attack tool 140, and victim server 120. The deployment may be as an on-prem device or a cloud-based managed solution. The deployment may be in-line of traffic or out of path, in an always on model.

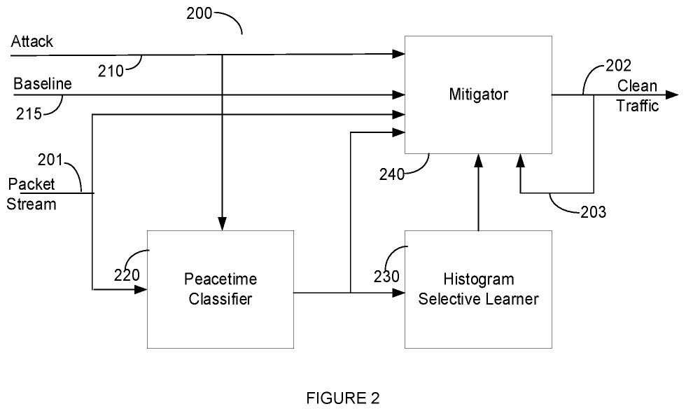

The defense system 200 is described in greater detail with respect of FIG. 2. Specifically, during peacetime, the defense system 200 is configured to baseline the normal behavior of the legitimate network traffic, and more specifically the legitimate packets flowing between the client's 130 and the server 120, and as further explained herein. In an embodiment, the peacetime operation includes clustering of packets and determination of legitimacy scores. Upon detection of an unusual and anomalous increase of traffic, the peacetime operation is ceased when an attack alert is provided. The detection of such increase of traffic may be indicative of a potential DDoS attack is in action. The detection may be performed by attack detection tools, the operation of which are outside of the scope of the disclosed embodiments.

Thereafter, packets received are checked against a multiplicity of legitimacy characteristics and a legitimacy score for each packet is determined in real time, and as further explained herein. In an embodiment, if a packet scores above a threshold it is characterized as legitimate (or clean); otherwise, the packet is characterized attack traffic. The threshold may be predefined or be adaptive so as to adjust the threshold based, for example, on reaching the peacetime levels, or volumes, of legitimate packets and increasing or decreasing the threshold in order to reach such level.

FIG. 2 is an example schematic diagram of the defense system 200 for packet-based characterization and mitigation of randomized DDoS attacks according to an embodiment. A packet stream 201 is received by the defense system 200 and directed to a peacetime packet classifier 220, also referred to herein as classifier 220, and to a mitigator 240. The system 200 further receives an attack signal 210 when it is determined that an attack has begun or is suspected to either begin or be present. The system 200 further receives baseline information 215 discussed herein with respect of a feedback 203.

The classifier 220 is configured to cluster packets as further explained herein. For example, one cluster may include packets that are the first packer from an IP source, another cluster may include packets that are a second packet from an IP source, yet another cluster may contain packets from a single-packet transaction, layer 4 (TCP or UDP or other) connection and so on and so forth Classification may be performed to cluster packets of a first seen source IP in one cluster, second seen source IP in another cluster, and long-lived transport layer connection packets in yet another cluster, and long-lived transport layer connection packets in yet another cluster.

A histogram selective learner 230, referred to also in short as the learner 230, is configured to build and provide a peacetime positive model. That is, contrary to the prior art that blacklists certain attacker constant traffic patterns, the crux of the operation of the system 200 is during an active attack to let through packets identified as part of a whitelist and block those not complying with the whitelist. Doing so avoids the problems associated with utilization of blacklists to prevent randomized DDoS attack, as developing the blacklist for a randomized attack is practically impossible. A blacklist will typically be a network layer signatures, most suitable to attacker with static traffic pattern. For example, a blacklist may comprise of an “attacker having a static traffic pattern”, consisting of “TCP SYN packets, of a size of 64 bytes, and a TOS header that equals to 44”.

The learner 230 is configured to generate legitimacy characteristics resulting from the histogram selective learning and as further explained herein in greater detail. The a legitimacy score for every received packet for each characteristic is determined based on the histograms of legitimacy characteristics. This legitimacy score is the key attribute for the actual attacker traffic characterization during an active attack. The legitimacy score (LS) may be a function of one or more legitimacy scores calculated for various characteristics as discussed herein. That is: LS=f(LS₁, LS₂, . . . , LSᵢ), where ‘i’ is an integer equal to or greater than ‘1’. In an embodiment, a weighted function may be used to determine the overall LS. A component legitimacy score may include the entropy, for example, of source IP legitimacy, and as further discussed herein.

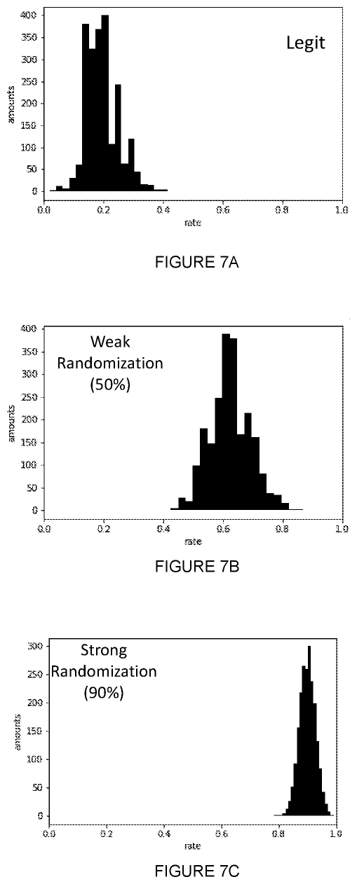

For example, but not byway of limitation, legitimacy characteristics for a first seen source IP of a packet may include, but are not limited to, packet size; UDP or TCP header components: source port and/or destination port; IP header components: differentiated services code point (DSCP) (type of service—TOS), total packet length, identification, flags, fragment offset; time to leave (TTL); time from previous packet; and the source IP entropy. For example, but not by way of limitation, f legitimacy characteristics for a second seen source IP of a packet may include, but not limited to, packet size; UDP or TCP header: source port and/or destination port; IP header: differentiated services code point, i.e., DSCP (TOS), total length, identification, flags, fragment offset; time to leave (TTL); the source IP entropy; and the actual time elapsed from previous packet. Entropy in this context is discussed with respect of FIGS. 7A-C herein.

For example, legitimacy characteristics for a long (more than a single packet) transport layer connection may include, but not limited to, packet size; UDP or TCP header: source port and/or destination port; IP header: DSCP (TOS), total length, identification, flags, fragment offset; time to leave (TTL); time from previous packet; average time between packets throughout the last period of time e.g. one second; transport layer connection length; number of changes in IP/UDP fields; number of concurrent connections; the source IP entropy; and, rate, i.e., the total number of packets and bytes that appear per time unit, for example per second. Similarly, in the case of a single packet transport layer connection it is also possible to determine legitimacy characteristics with dimensions such as, but not limited to, packet size; UDP or TCP header: source port and/or destination port; IP header fields, such as DSCP (TOS), total length, identification, flags, fragment offset; time to leave (TTL); time from previous packet; and the source IP entropy, and the entropy and the reputation of the source IP. The reputation history of source IP may be provided by a third-party service. The reputation may include a score indicative on SPAM issues, threats, or elevated IP fraud scores that could be causing your IP address to be blocked and blacklisted. The source IP entropy allows to determine the legitimacy characterization, during a time period, on the entire packets received by the system 200, and not per packets as per single packet or per connection as per the other. The source IP entropy is further discussed with respect of FIGS. 7A-C herein.

The learner 230 is configured to provide each incoming packet, when clustered for each cluster classified by the classifier 220, with the one or more legitimacy characterization characteristics. During peace time, the learner 230 therefore is configured to analyze the incoming clustered packets and provides distributions of packets information in multiple dimensions for each of the clusters provided by the classifier 220. In an embodiment, the output of the learner 230 are stable and efficient histograms, i.e., dynamic histograms with non-equal sized bins. In yet another embodiment, the output of the learner 230 are histograms with equal sized bins. According to an embodiment, histograms can be learnt selectively, i.e., over selective periods of time and not necessarily continuously. This is performed at peacetime thereby creating a normal baseline for the peacetime expected behavior of packets flowing over the network. Moreover, when such pattern departs from expected histograms it is indicative that an attack is present, and in particular of the type of random DDoS attack.

Accordingly, during peacetime, i.e., at the learning period, but also thereafter, the system 200 is configured to examine the incoming packets and analyzes values of each legitimacy characteristic. In an embodiment, the learner 230 is further configured to build one or more histograms over one or more of these features. In an embodiment, each predefined period of time, e.g., 10 seconds, a distribution is determined from each of the histogram. In another embodiment, a distribution is calculated from each of the histogram each pre-defined number of incoming packets received at the system 200.

The mitigator 240, that receives the packet stream 201, is further configured to receive the peacetime positive model generated by the learner 230. The model provides one or more legitimacy characterization characteristics. During “peacetime”, i.e., while no attack is present or detected, the packet flow may flow through the mitigator 240 uninterrupted as clean traffic 202. That is, the primary function of the mitigator 240 is to handle incoming packets during a period of an active attack and whitelist those packets that can continue as clean traffic 202 while applying a mitigation action on packets that are determined not to be whitelisted, and as further explained herein. A mitigation action may include blocking such packets, sending such packets to a scrubbing center, alerting and reporting on such packets, counting of such packets and so on, or combination thereof.

When an attack signal 210 is provided to the mitigator 240, the mitigator 240 begins to check every packet received against the current one or more baseline legitimacy characterization characteristics provided by the learner 230 and learned during peacetime. The mitigator 240 is configured to provide for each packet received during an attack a score on each of the legitimacy dimensions relevant to the cluster to which the packet is associated with. In an embodiment, the overall legitimacy result for a received packet is computed and if it is above a legitimacy threshold then the packet is legitimate and if it is below such threshold the packet is rejected. Packets that were cleared for the server 120 are output from the mitigator 240 as clean traffic 202.

In an embodiment of the mitigator 240, feedback 203 is provided that is configured to ensure that the packets leaving the mitigator 240 bring the level of clear traffic 202 to a level consistent with a normal pre-attack volumes and characteristic, as provided, for example, as baseline information 215. The feedback mechanism is configured to examine data about the clean traffic 202 received as feedback 203 and compare that with the normal baseline traffic learned at peacetime, that baseline information provided, for example, to the mitigator 240 as baseline information 215. Thresholds can be then adjusted upwards or downwards, as the case may be, for the purpose of determination of an optimal threshold for acceptance or rejection of packets. As noted, depending on the specific configuration, threshold may be determined to be above or below depending on any particular implementation and it should be understood that whitelists may go either way but are consistent once implemented.

It should be noted that the elements discussed with reference to FIG. 2, that is, a peacetime packet classifier 220, a learner 230, and a mitigator 240 may be realized as one or more hardware logic components and circuits. For example, and without limitation, illustrative types of hardware logic components that can be used include field-programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), artificial intelligence (AI) processors, and the like, whether general purpose or specialized processors, or any other hardware logic components that can perform calculations or other manipulations of information.

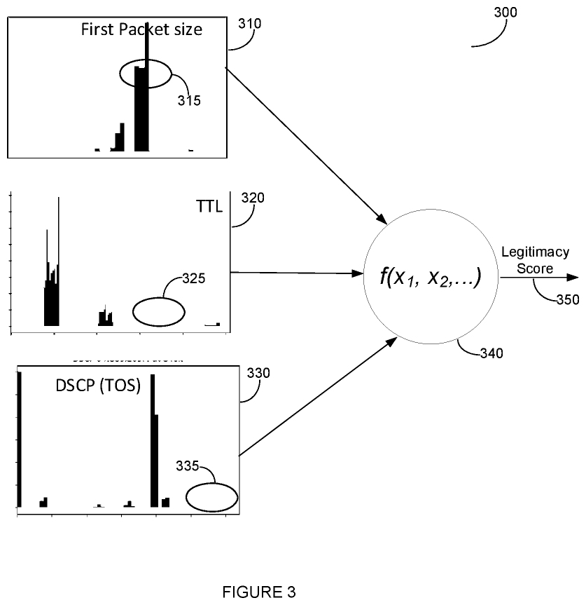

FIG. 3 is an example schematic diagram of a positive security model 300 implemented according to an embodiment, for example but not by way of limitation as shown in FIG. 2. In this case a packet is classified as a first packet from an IP source. In this example, there are three legitimacy characteristics: packet size dimension having a packet size legitimacy characteristics 310, a TTL legitimacy characteristics 320, and a DSCP (TOS) legitimacy characteristics 330.

Each legitimacy characterization, that was determined at peacetime, i.e., during a known period of no attacks, provides an expected whitelisting profile, or the normal baseline, for that particular dimension of legitimacy characterization. The profiles, in embodiment, are presented as a distribution of the respective legitimacy characterizations 310, 320 and 330 which are dimensions used for a specific cluster, for example a first packet received from an IP source. Each distribution is built from histogram over each value of every feature, or dimension. When a packet is received its characteristics are compared against each of the legitimacy characteristics dimensions 310, 320 and 330. For example, during an active attack a packet is received by the mitigator 240 and its actual characteristics 315, 325 and 335 in each of the dimensions are checked against the normal legitimacy characterizations distributions 310, 320 and 330. As a result, a legitimacy score is generated by the mitigator 240 based on how well the dimensions characteristics of the packet received matches that of the legitimacy characterizations 310, 320 and 330, or dimensions characteristics of the packet received fit the normal behavior and can potentially be whitelisted.

In the packet size dimension, the received packet size 315 is within the range of the high probability legitimacy characteristic dimension of packet size, and therefore receives, for example, a score of 0.9. In other cases when the received packet size might be within the range of low probability legitimacy characteristic dimension of packet size, and therefore receives a lower score. In the TTL dimension, the received packet is outside the range of the legitimacy characteristic dimension of TTL, TLL value 325 is with low probability, and therefore receives, for example, a score of 0.2. This may further consider the probability of the occurrence outside of the range. In the DSCP (TOS) dimension, the received packet is outside the range of the legitimacy characteristic dimension of DSCP (TOS), a DSCP value 335 is with a low probability and therefore receives, for example, a score of 0.25.

In an embodiment, a multi-dimensional scoring function 340 aggregates the score to generate a legitimacy score 350 for the received packet. The legitimacy score 350 is the score that is compared against a predetermined threshold and if the legitimacy score 350 is equal to or above the threshold then the packet is legitimate, i.e., whitelisted and passes safely by the mitigator 240, or, if it is below the threshold level, the packet is blocked by the mitigator 240. As noted, in another embodiment an opposite threshold may be used without departing from the scope of the disclosed embodiments.

The model shown in FIG. 3 is an example and additional dimensions may be included without departing from the scope of the disclosed embodiments. It should be noted that the more dimensions used the more accurate the whitelisting performed according to the disclosed embodiments becomes. Due to the huge number of packets per second that are provided to the defender system 200, and the number of legitimacy dimensions used, it should be understood that such operations cannot and will not be performed using the human mind or by performing the operation using paper and pencil.

Furthermore, a human operator applies subjective criteria to analyze/determine/classify, leading to results which are not consistent between different human operators, and often not consistent between the same human performing the same task repeatedly, and in particular at the speeds required to provide an operable solution. The number of possibilities of packet classification in peacetime in general, and received packets during an attack time in particular, by far exceeds any particle use of the human mind.

In contrast, the system uses a set of predefined objective criteria, such as the various legitimacy dimensions used, and the manner in which classification into clusters is performed. This results in solving the problem of whitelisting received packets during a randomized DDoS attack in a reliable and consistent manner based on the objective criteria.

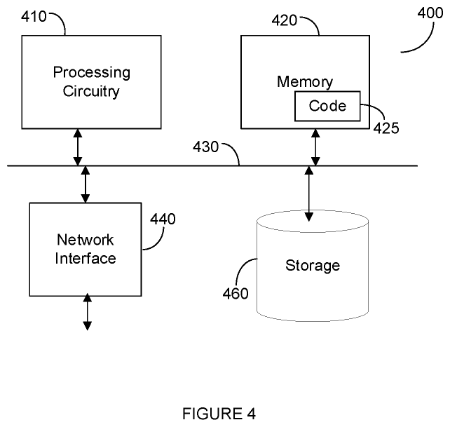

FIG. 4 is a block diagram of an example embodiment of the defense system 200 utilized to carry the disclosed embodiments. The defense system 400 includes a processing circuitry 410 that is communicatively connected by a bus 430 to a memory 420. The memory 420 may further contain therein a portion that is dedicated to memory code 425. A network interface 440 is communicatively connected to the processing circuitry 410 using the bus 440. In an embodiment, storage unit 460 may be further communicatively connected to the bus 430.

The processing circuitry 410 may be realized as one or more hardware logic components and circuits. For example, and without limitation, illustrative types of hardware logic components that can be used include field-programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, whether general purpose or specialized processors, or any other hardware logic components that can perform calculations or other manipulations of information. The processing circuitry 410 is configured to detect and mitigate randomized DDoS attacks as described herein.

The memory 420 may be volatile, e.g., random access memory (RAM) etc., non-volatile, e.g., read only memory (ROM) flash memory, etc., or a combination thereof. In one configuration, computer-readable instructions to implement one or more embodiments disclosed herein may be stored in memory code 425. In another embodiment some or all of the computer-readable instructions to implement one or more embodiments disclosed herein may be stored in storage 460.

In another embodiment, the memory 420 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 910 to perform the various processes described herein. Specifically, the instructions, when executed, cause the processing circuitry 410 to perform the embodiments described herein.

The storage 460 may be magnetic storage, optical storage, and the like, and may be realized, for example, as flash memory, for example in the case of solid-state disk (SSD) or other memory technology, CD-ROM, Digital Versatile Disks (DVDs), or any other medium which can be used to store the desired information.

The network interface 440 allows the device 400 to communicate at least with the servers and clients. The network interface 440 may be an interface to a local area network (LAN), a wide area network (WAN), the Internet, a cloud network, a cellular network, and a metropolitan area network (MAN), wired network, wireless network, IoT network, like networks, or any combination thereof.

It should be understood that the embodiments described herein are not limited to the specific architecture illustrated in FIG. 4, and other architectures may be equally used without departing from the scope of the disclosed embodiments. Further, the system 110 can be structured using the arrangement shown in FIG. 4.

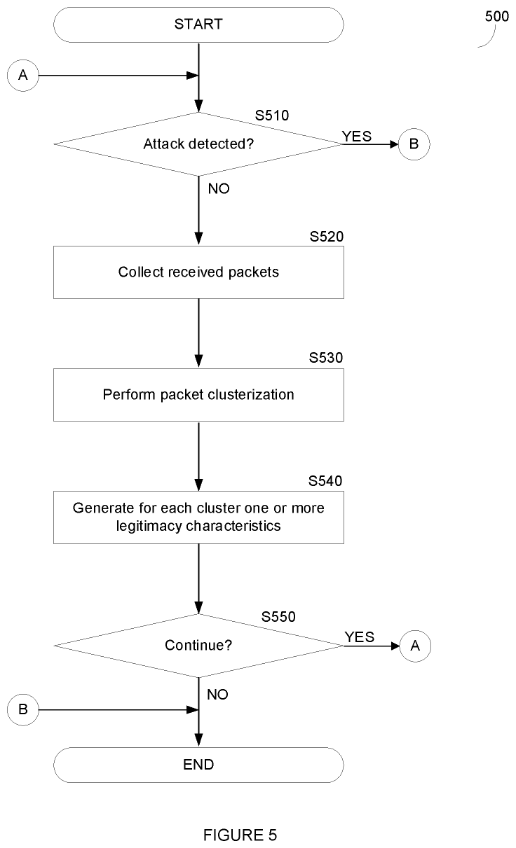

FIG. 5 is an example flowchart 500 of a method for packet-based characterization of randomized DDoS attacks according to an embodiment. The method is performed at peacetime, when no attack traffic is detected.

At S510, it is checked if an attack signal has been detected, and if not, execution continues with S520; otherwise, execution terminates, and the attack-time flowchart 600 is utilized as described herein.

At S520, received packets are temporarily collected and stored. In an embodiment, the samples of incoming packet stream packets are used for legitimacy characteristics building for packet-based characterization of randomized DDoS attacks.

At S530, the collected packets are clustered so that one or more clusters of packets are generated. Each cluster represents characteristics common to the packets associated with the cluster. As an example, the cluster may include first and second seen IP source addresses and a short-term connection and a long-term connection. Such clusters are discussed herein in greater detail and not repeated herein.

At S540, legitimacy characterizations are generated for each cluster. The legitimacy characterizations represent normal structure of packets in each cluster across multiple dimensions. As noted above, legitimacy characterizations are defined for a first seen source IP of a packet may include, but not limited to, packet size; UDP or TCP header: source port and/or destination port; IP header: differentiated services code point (DSCP) (type of service—TOS), total packet length, identification, flags, fragment offset; time to leave (TTL); and the source IP entropy. For example, but not by way of limitation, legitimacy characterizations for a second seen packets from a source IP of a packet may include, but not limited to, packet size; UDP or TCP header: source port and/or destination port; IP header: DSCP (TOS), total length, identification, flags, fragment offset; time to leave (TTL); the source IP entropy; and the actual time elapsed from previous packet. For example, but not by way of limitation, legitimacy characterizations for a connection, may include, but are not limited to, packet size; UDP or TCP header: source port and/or destination port; IP header: DSCP (TOS), total length, identification, flags, fragment offset; time to leave (TTL); the source IP entropy; and the actual time elapsed from previous packet, connection duration in seconds and connection volume in number of bits and number of packets.

Legitimacy characterizations are statistics behavior of legitimate traffic (sent by a legitimate client) as observed and learned during peacetime. In an embodiment, the statistics behavior can be modeled using dynamic histogram with equal or non-equal size bins. Such histograms can be learnt “selectively”, i.e., over selective periods of time and not continuously. In an embodiment, the histograms are built during peace time. For each bin of the histogram, data is aggregated and averaged each pre-defined period of time, using exponential average or similar. From the histogram, a distribution is calculated.

At S550 it is checked whether an attack was detected, and peacetime operation is to cease, and if so, execution terminates; otherwise, execution returns to S510.

In one embodiment the flowchart 500 is operative on the defense system 200. In another embodiment the flowchart 500 is operative on the defensive system 400, where it may be implemented as instructions stored in memory, for example code memory 425, executed by processing circuitry 410, thereby configuring the defense system 200 to generate the attack-time response based on legitimacy characteristics scores and passing whitelisted packets while mitigating, e.g. blocking, packets that have not achieved the desired level of legitimacy as described herein.

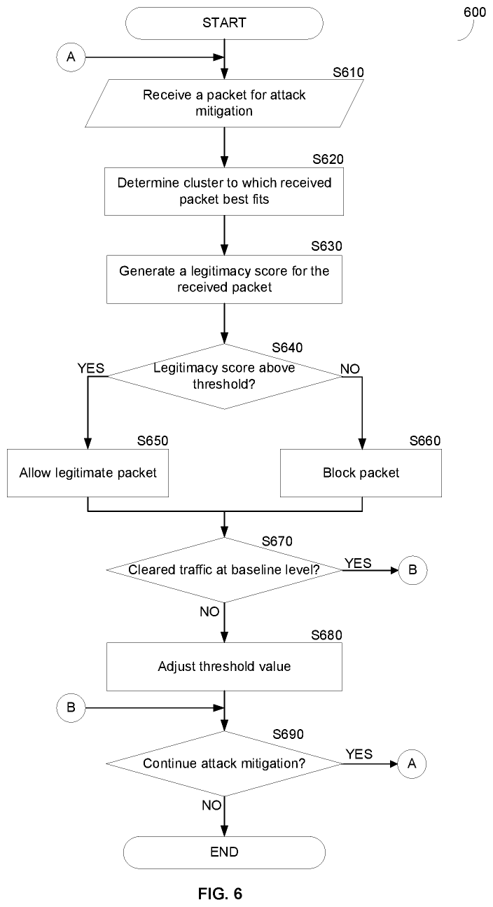

FIG. 6 is an example flowchart 600 of a method for packet-based mitigation of randomized DDoS attacks according to an embodiment.

At S610, a packet is received subsequent to receiving an attack alert signal, for example that a randomized DDoS attack is in progress.

At S620, it is determined to which cluster the packet received is best fit to. For example, if the received packet can be part of the first seen IP source address cluster or the second seen IP source address cluster or connection cluster.

At S630, the legitimacy score for the received packet is determined, as further described herein. In an embodiment, the score is first determined for each dimension relevant to the specific cluster to which the received packet was classified to, and then, using the multi-dimensional scoring function determining a final legitimacy score for the received packet.

At S640 it is checked whether the score is above a predetermined legitimacy threshold, and if so, at S650 the packet is cleared and allowed to continue as clean traffic; otherwise, at S660, a mitigation action is performed on the packet. In an embodiment, the mitigation action includes blocking from flowing as part of the clear traffic. In another embodiment the mitigation includes diverting the received packet to a scrubbing center (not shown). In yet another embodiment the mitigation includes, generating an alert on the received packet, report and account its occurrences.

In one embodiment, optional S670 and S680 provide for a feedback loop where it is checked whether the clear traffic 202 is at the expected baseline level of traffic flow for peacetime networking. If such feedback loop is not done then execution continue from either S650 or S660 to S690, and as further explained herein.

At S670, it is checked whether the clear traffic is at, or essentially within, the level of the baseline traffic, as was present prior to the attack. If the level is at essentially the baseline level, which may be determined as plus or minus of a predetermined value, for example +/−1%, +/−5%, or any other desirable value, then execution continues with S690; otherwise, execution continues with S680.

At S680 the threshold value is adjusted upwards or downwards depending on if an over adjustment or under adjustment has occurred.

In an embodiment, operations S670 and S680 are performed on each pre-defined number of packets and not on a per-packet basis.

At S690 it is checked whether the attack continues and therefore execution should return to S610; otherwise, as an attack has ceased, execution terminates.

In one embodiment the flowchart 600 is operative on the defense system 200. In another embodiment the flowchart 600 is operative on the defensive system 400, where it may be implemented as instructions stored in memory, for example code memory 425, executed by processing circuitry 410, thereby configuring the defense system 200 to generate the attack-time response based on legitimacy scores and passing whitelisted packets while blocking packets that have not achieved the desired level of legitimacy as described herein.

The solution provided herein therefore provides multi-dimension legitimacy attributes. These may be at the network layer (L3 IP), which include but are not limited to IP header (TTL, DSCP, IP length, flags, fragments, total packet size) distribution, as well as time between packets distributions. These may further be at the connection layer (L4 TCP/UDP), as well as higher protocol layers. For example, but not by way of limitation, UDP header (source and destination ports) distributions, connection (duration, bandwidth) distributions, first packet from a specific source IP network behavior, and second packet from a specific source IP network behavior. Furthermore, per source behaviors may also be characterized for legitimacy, including but not limited to source IP entropy and source IP reputation.

The source IP entropy can be measured as a distinct rate for a group of ‘n’ consecutive samples of incoming packets stream 201 arriving at system 200 in FIG. 2 for each specific source IP sends traffic directed to the server 120. The distinct rate for a group of ‘n’ sample packets send by a source IP is the number of distinct values divided by ‘n’, or by the total number of samples. The ‘n’ can be selected to any pre-defined number of packets. In the latter case, the legitimacy metric is generated based on the past behavior of an IP source. The source IP entropy can be measured for the IP transport/network layer attributes, such as packet size, TTL, DSCP, port number, and the like appeared at the IP packets the source transmits. These are exemplary attributes and others may be added to the list without departing from the scope of the disclosed embodiments.

The source IP entropy dimension is a legitimacy characteristics metric which is built, or calculated, not on a per packet but rather per the past behavior of an IP source and by that reflects its short-term behavior.

FIG. 7A shows a legitimate source IP entropy detected according to an embodiment during peacetime with not active randomized attacker traffic is presented. For legitimate source IP the entropy is relatively low as can be seen in the exemplary distinct rate for a legitimate source IP. Hence this entropy provides a legitimacy feature from which a legitimacy score may be calculated as discussed herein.

FIG. 7B shows a source IP entropy of a weak randomized DDoS attack detected according to an embodiment. Here, as the attacker randomizes the size of the packet he generates and therefore it is indicative of a malicious attack traffic as it introduces more distinct packet size values than an average legitimate client. Hence this source IP entropy provides a legitimacy feature, from which a legitimacy score may be calculated as discussed herein, that is substantially different than the one introduced by a legitimate client source IP during peace time, and presented in FIG. 7A.

FIG. 7C shows a source IP entropy of a strong randomized DDoS attack detected according to an embodiment. In this case the entropy is substantially different than introduced by a legitimate source IP, as significantly more randomization in packet sizes is presented and vast number of distinct values appeared. Therefore, this entropy technique shown herein clearly depicts the difference between legitimate traffic and illegitimate traffic, even with weak randomization. Hence this entropy provides another legitimacy feature from which a legitimacy score may be calculated as discussed herein.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

What is claimed is:

1. A method for mitigation of randomized denial-of-service (DDoS) attacks directed against a protected entity during an attack time period, comprising:
receiving a packet during the attack time period;
selecting a cluster defining legitimacy characteristics from at least one cluster of packets that best fits the received packet, wherein legitimacy characteristics of a cluster are learned during a peacetime period;
determining a legitimacy score for the received packet based on the legitimacy characteristics of the selected cluster;
determining based on the legitimacy score if the received packet is not legitimate; and
applying a mitigation action on the received packet upon determination that the packet is not legitimate.

2. The method of claim 1, wherein the mitigation action is any of: blocking the received packet, diverting the received packet to a scrubbing center to results with clean traffic, and generating an alert on a potential attack.

3. The method of claim 1, wherein the selected cluster is any one of: a first seen source internet protocol (IP) packet, a second seen source IP packet, a short transport layer protocol and a long transport layer connection.

4. The method of claim 3, wherein determining based on the legitimacy score if the received packet is not legitimate, further comprises:
comparing the legitimacy score to a legitimacy threshold; and
determining the received packet to be not legitimate if the legitimacy score exceeds the legitimacy threshold.

5. The method of claim 4, further comprising:
checking when the mitigated traffic is at a baseline level determined prior to commencement of the attack; and
adjusting the legitimacy threshold value in a direction that attempts to cause the clean traffic to reach the baseline level.

6. The method of claim 1, wherein learning legitimacy characteristics of a cluster during the peacetime period further comprising:
collecting a plurality of received packets directed to the protected entity;
classifying the plurality of received packets into at least one cluster; and
learning for each of the at least one cluster legitimacy characteristics.

7. The method of claim 6, wherein collecting the plurality of received packets further comprises:
sampling the plurality of received packets directed to the protected entity.

8. The method of claim 6, wherein a legitimacy characteristic characterizes behavior of a legitimate client as seen at peace time during a period of time.

9. The method of claim 6, wherein learning legitimacy characteristics further comprises any one of:
learning network attributes statistic characterization;
learning communication protocol attributes statistic characterization;
learning entropy of a source IP address of a received packet; and
learning reputation of a source of a received packet.

10. The method of claim 9, wherein learning entropy of the source IP further comprising:
determination of a distinct rate for a group of ‘n’ sample packets sent by a source IP.

11. The method of claim 10, wherein the distinct rate is determined by one of: the number of distinct values divided by ‘n’, or the number of distinct values divided by the total number of samples.

12. The method of claim 6, wherein a legitimacy characteristic of a seen source IP packet type cluster is any of: a packet size of the received packet, a UDP header fields components of the received packet, TCP header fields components of the received packet, entropy of a source IP address of the received packet, and a reputation of a source IP address of the received packet.

13. The method of claim 6, wherein a legitimacy characteristic of a connection type cluster is any of: a time to leave (TTL) of a connection, a time from previous packet received on a connection, average time between packets throughout a connection, a connection length, a connection duration, a number of changes in IP headers fields, a number of changes in UDP or TCP headers fields, a number of concurrent connections, a connection packet rate, and a connection byte rate, wherein the connection is a long transport layer connection on which the received packet is received.

14. The method of claim 1, wherein determining the legitimacy score further comprises:
determining a cluster legitimacy score for each selected cluster based on histogram legitimacy characteristics of the selected cluster; and
determining the legitimacy score as a function of the determined cluster legitimacy scores.

15. A system for mitigation of randomized denial-of-service (DDoS) attacks at attack time, comprising:
a processing circuitry;
a network interface communicatively connected to the processing circuitry; and
a memory communicatively connected to the processing circuitry, a portion of the memory containing therein instructions that when executed by the processing circuitry configure the system to: receive a packet during the attack time period; selecting a cluster defining legitimacy characteristics from at least one cluster of packets that best fits the received packet, wherein legitimacy characteristics of a cluster are learned during a peacetime period; determine a legitimacy score for the received packet based on the legitimacy characteristics of the selected cluster; determine based on the legitimacy score if the received packet is not legitimate; and, apply a mitigation action on the received packet upon determination that the packet is not legitimate.

16. The system of claim 15, wherein the mitigation action is any of: blocking the received packet, diverting the received packet to a scrubbing center to results with clean traffic, and generating an alert on a potential attack.

17. The system of claim 15, wherein the selected cluster is any one of: a first seen source internet protocol (IP) packet, a second seen source IP packet, a short transport layer protocol and a long transport layer connection.

18. The system of claim 17, wherein determination based on the legitimacy score if the received packet is not legitimate, further comprises: comparison of the legitimacy score to a legitimacy threshold; and, determination of the received packet to be not legitimate if the legitimacy score exceeds the legitimacy threshold.

19. The system of claim 18, the instructions further comprise: a check when the mitigated traffic is at a baseline level determined prior to commencement of the attack; and, adjustment the legitimacy threshold value in a direction that attempts to cause the clean traffic to reach the baseline level.

20. The system of claim 15, wherein learning legitimacy characteristics of a cluster during the peacetime period further comprises: collect a plurality of received packets directed to the protected entity; classify the plurality of received packets into at least one cluster; and, learn for each of the at least one cluster legitimacy characteristics.

21. The system of claim 20, wherein collection of the plurality of received packets further comprises: sample the plurality of received packets directed to the protected entity.

22. The system of claim 20, wherein a legitimacy characteristic characterizes behavior of a legitimate client as seen at peace time during a period of time.

23. The system of claim 20, wherein the system is configured to perform any one:
learn network attributes statistic characterization;
learn communication protocol attributes statistic characterization;
learn entropy of a source IP address of a received packet; and
learn reputation of a source of a received packet.

24. The system of claim 23, wherein learning entropy of the source IP further comprises determination of a distinct rate for a group of ‘n’ sample packets sent by a source IP.

25. The system of claim 24, wherein the distinct rate is determined by one of: the number of distinct values divided by ‘n’ or the number of distinct values divided by the total number of samples.

26. The system of claim 20, wherein a legitimacy characteristic of a seen source IP packet type cluster is any of: a packet size of the received packet, a UDP header fields components of the received packet, TCP header fields components of the received packet, entropy of a source IP address of the received packet, and a reputation of a source IP address of the received packet.

27. The system of claim 20, wherein a legitimacy characteristic of a connection type cluster is any of: a time to leave (TTL) of a connection, a time from previous packet received on a connection, average time between packets throughout a connection, a connection length, a connection duration, a number of changes in IP headers fields, a number of changes in UDP or TCP headers fields, a number of concurrent connections, a connection packet rate, and a connection byte rate, wherein the connection is a long transport layer connection on which the received packet is received.

28. The method of claim 15, wherein determination the legitimacy score further comprises: determination of a cluster legitimacy score for each selected cluster based on histogram legitimacy characteristics of the selected cluster; and, determination of the legitimacy score as a function of the determined cluster legitimacy scores.

29. A non-transitory computer readable medium having stored thereon instructions for causing a processing circuitry to execute a process, the process comprising:
receiving a packet during the attack time period;
selecting a cluster defining legitimacy characteristics from at least one cluster of packets that best fits the received packet, wherein legitimacy characteristics of a cluster are learned during a peacetime period;
determining a legitimacy score for the received packet based on the legitimacy characteristics of the selected cluster;
determining based on the legitimacy score if the received packet is not legitimate; and
applying a mitigation action on the received packet upon determination that the packet is not legitimate.
